(19) United States
(12) Patent Application Publication
(10) Pub. No.: US 2018/0351622 A1
(43) Pub. Date: Dec. 6, 2018

(54) Method and Apparatus for Feeding back Channel State Information, Method and Apparatus for Allocating Resources and Communications System

(71) Applicant: FUJITSU LIMITED, Kawasaki-shi (JP)

(72) Inventors: Wei XI, Beijing (CN); Hua ZHOU, Beijing (CN)

(73) Assignee: FUJITSU LIMITED, Kawasaki-shi (JP)

(21) Appl. No.: 16/040,911

(22) Filed: Jul. 20, 2018

Related U.S. Application Data
(63) Continuation of application No. PCT/CN2016/072746, filed on Jan. 29, 2016.

(51) Int. Cl. H04B 7/06; H04B 17/24; H04B 17/309; H04W 72/08; H04W 8/00; H04W 72/12

(52) U.S. Cl. CPC H04B 7/0626; H04B 17/24; H04B 17/309; H04W 72/0453; H04W 8/005; H04W 72/121; H04W 72/085

(57) ABSTRACT

A method and apparatus for feeding back channel state information, a method and apparatus for allocating resources and a communications system. The method for feeding back channel state information includes: a UE feeds back channel state information to a base station, the channel state information including a link ID of a link between the UE and a neighboring UE, and/or a UEID of the neighboring UE, so that the base station allocates resources for each UE according to channel state information fed back by each UE. Hence, resource collision is reduced, and signal quality is improved.

### CROSS REFERENCE TO RELATED APPLICATIONS

This application is a continuation application of International Application PCT/CN2016/072746 filed on Jan. 29, 2016, the entire contents of which are incorporated herein by reference.

### FIELD

This disclosure relates to the field of communications technologies, and in particular to a method and apparatus for feeding back channel state information, a method and apparatus for allocating resources and a communications system.

### BACKGROUND

In recent years, vehicle to vehicle (V2V) communications have gradually become a hotspot of studies in the field of wireless communications. In the future, not only connection between vehicles may be made, but also vehicles may be connected to the Internet freely. Such “an Internet of vehicles” is a completely new concept, and a large quantity of applications shall emerge, thereby outstandingly changing our lives. Hence, attention of a large number of research institutes and standardization organizations has been drawn to “the Internet of vehicles”. Till now, a large quantity of V2V communications systems and projects have emerged, typically, Institute of Electrical and Electronics Engineers (IEEE) 802.11p dedicated short range communications (DSRC), and intelligent transportation systems (ITSs), etc.

On the other hand, worldwide great success of long term evolution (LTE) and LTE-advanced systems has brought about new opportunities for the V2V communications, which makes it possible that vehicles are connected to each other and vehicles are connected to the Internet. As LTE/LTE-advanced support device to device (D2D) communications, a most direct scheme is to achieve V2V communications based on a PC5 interface of D2D.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that in comparison with the D2D communications, the V2V communications require lower latency and higher reliability. For example, latency of the V2V communications is often required to be lower than 100 milliseconds; and as security is concerned in traffics of the V2V communications, requirements of the V2V communications are extremely rigorous and severe with respect to reliability. Facing such severe technical requirements, legacy mechanisms originally addressed to D2D need to be enhanced in every aspect, such as optimizing resource pool structures, reducing resource collisions, overcoming relatively large Doppler spread, and enhancing demodulation reference signals and synchronization signals, etc.

Embodiments of this disclosure provide a method and apparatus for feeding back channel state information, a method and apparatus for allocating resources and a communications system, aiming at reducing resource collisions and improving signal quality.

According to a first aspect of the embodiments of this disclosure, there is provided a method for feeding back channel state information, including:

feeding back channel state information by a UE to a base station, the channel state information including a link ID of a link between the UE and a neighboring UE, and/or a UEID of the neighboring UE, so that the base station allocates resources for each UE according to the channel state information fed back by each UE.

According to a second aspect of the embodiments of this disclosure, there is provided a method for allocating resources, including:

receiving, by a base station, channel state information fed back by a UE, the channel state information including a link ID of a link between the UE and a neighboring UE, and/or a UEID of the neighboring UE; and

allocating resources by the base station for each UE according to the channel state information fed back by each UE.

According to a third aspect of the embodiments of this disclosure, there is provided an apparatus for feeding back channel state information, configured in a UE, the apparatus including:

a transmitting unit configured to feed back channel state information to a base station, the channel state information including a link ID of a link between the UE and a neighboring UE, and/or a UEID of the neighboring UE, so that the base station allocates resources for each UE according to the channel state information fed back by each UE.

According to a fourth aspect of the embodiments of this disclosure, there is provided an apparatus for allocating resources, configured in a base station, the apparatus including:

a receiving unit configured to receive channel state information fed back by a UE, the channel state information including a link ID of a link between the UE and a neighboring UE, and/or a UEID of the neighboring UE; and

an allocating unit configured to allocate resources for each UE according to the channel state information fed back by each UE.

According to a fifth aspect of the embodiments of this disclosure, there is provided a UE, including the above-described apparatus for feeding back channel state information.

According to a sixth aspect of the embodiments of this disclosure, there is provided a base station, including the above-described apparatus for allocating resources.

According to a seventh aspect of the embodiments of this disclosure, there is provided a communications system, including a base station and a UE; wherein,

the UE is configured to feed back channel state information to the base station, the channel state information including a link ID of a link between the UE and a neighboring UE, and/or a UEID of the neighboring UE;

and the base station is configured to receive the channel state information fed back by the UE, and allocate resources for each UE according to the channel state information fed back by each UE.

An advantage of the embodiments of this disclosure exists in that with the methods, or apparatuses or system of the embodiments of this disclosure, resource collisions may be reduced and signal quality may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of the method for feeding back channel state information of Embodiment 1 of this disclosure;

FIG. 2 is a schematic diagram of the method for allocating resources of Embodiment 2 of this disclosure;

FIG. 3 is a schematic diagram of an implementation of resource allocation in the method shown in FIG. 2;

FIG. 4 is a schematic diagram of an application scenario;

FIG. 5 is a schematic diagram of time-domain resource allocation;

FIG. 6 is a schematic diagram of frequency-domain resource allocation;

FIG. 7 is a schematic diagram of the apparatus for feeding back channel state information of Embodiment 3 of this disclosure;

FIG. 8 is a schematic diagram of the UE of Embodiment 3 of this disclosure;

FIG. 9 is a schematic diagram of the apparatus for allocating resources of Embodiment 4 of this disclosure;

FIG. 10 is a schematic diagram of a second allocating module in the apparatus shown in FIG. 9;

FIG. 11 is a schematic diagram of the base station of Embodiment 4 of this disclosure; and

FIG. 12 is a schematic diagram of the communications system of Embodiment 5 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of this disclosure shall be described with reference to the accompanying drawings. These embodiments are illustrative only, and are not intended to limit this disclosure.

In this disclosure, a base station may be referred to as an access point, a broadcast transmitter, a node B, or an evolution node B (eNB), etc., and may include some or all functions of them. Term “base station” is used in the text, and each base station provides communications coverage for a specific geographical region.

In this disclosure, a mobile station or equipment may be referred to as user equipment (UE). The UE may be fixed or mobile, and may also be referred to as a mobile station, a terminal, an access terminal, a user unit, or a station, etc. The UE may be a cellular phone, a personal digital assistant (PDA), a wireless modem, a wireless communications device, a handhold device, a lap-top computer, a cordless telephone, and a vehicle, etc.

### Embodiment 1

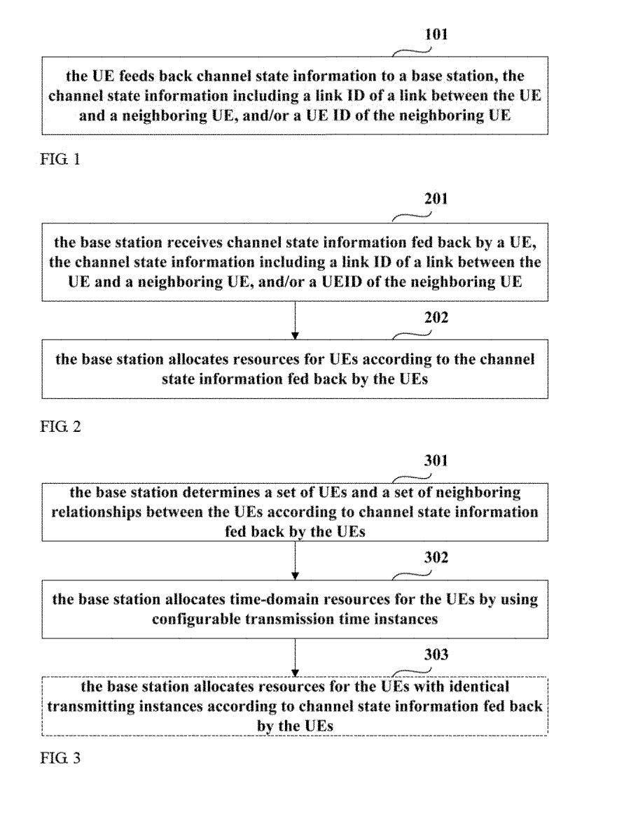

The embodiment of the present disclosure provides a method for feeding back channel state information, applicable to a UE. FIG. 1 is a schematic diagram of the method of this embodiment of this disclosure. As shown in FIG. 1, the method includes:

step 101: the UE feeds back channel state information to a base station, the channel state information including a link ID of a link between the UE and a neighboring UE, and/or a UEID of the neighboring UE, so that the base station allocates resources for each UE according to the channel state information fed back by each UE.

In this embodiment, the UE may be, for example, a terminal of the above-described Internet of vehicles. However, this disclosure is not limited thereto; for example, the UE may also be a terminal of another network system. The embodiments of this disclosure shall be described by taking the Internet of vehicles as an example only. However, this disclosure is not limited thereto, and it is applicable to any system performing channel information feedback or resource allocation.

In this embodiment, the base station may be a macro base station (such as an eNB), and the UE may be served by macro cells generated by the macro base station. And the base station in the embodiments of this disclosure may also be a pico base station, and the UE may be served by pico cells generated by the pico base station. However, this disclosure is not limited thereto, and a particular scenario may be determined according to an actual situation.

In this embodiment, by feeding back the above channel state information to the base station, the UE assists the base station in constructing topology of UEs, so as to allocate resources for the UEs. Hence, resource collisions may be reduced and signal quality may be improved.

In this embodiment, the above link may be a sidelink between UEs, and the above link ID may be an ID of the sidelink. However, this embodiment is not limited thereto, and the above link may also be a link of another type, or may have another name, according to a type of a communications system. In this embodiment, for the sake of convenience of description, a sidelink and a sidelink ID are taken as examples.

In this embodiment, the above sidelink identity (SLID) may be obtained by detecting sidelink synchronization signals (SLSSs) of the surrounding UEs, a particular method for detection and a method for obtaining the above SLID being not limited in this embodiment.

In this embodiment, the above user equipment identity (UEID) may be obtained via a physical sidelink discovery channel (PSDCH), a particular method for obtaining being not limited in this embodiment.

In this embodiment, besides the above SLID and/or the UEID, the channel state information may further include any one of the following or a combination thereof:

received signal strength from each neighboring UE received by the UE; and/or estimated distance from the UE to each neighboring UE; and/or estimated path loss from the UE to each neighboring UE.

By feeding back the above information by the UE, the base station may make reference to the information in constructing the topology of the UEs, so as to more accurately understand relationships between the UEs, and provide reference for constructing the topology of the UEs or allocating resources for the UEs.

The contents of the above channel state information are illustrative only. And in particular implementations, the UE may further feed back other channel state information to the base station as demanded, such as the ID of the UE, etc., and this embodiment is not limited thereto.

In this embodiment, resources for feeding back the channel state information may include a physical uplink shared channel (PUSCH) and/or a physical uplink control channel (PUCCH), that is, the UE may feed back the above channel state information via a physical uplink channel. For example, each UE feeds back the above channel state information via a PUSCH configured by the base station for it. And for another example, each UE feeds back the above channel state information via a PUCCH configured by the base station for it. In this embodiment, for aperiodic feedback, a PUSCH may be considered for use, and for periodic feedback, a PUCCH may be considered for use; however, this embodiment is not limited thereto.

In this embodiment, a manner for triggering feedback of the channel state information may be divided into a passive mode and an active mode. As for the passive mode, the feedback is triggered by the base station, that is, the UE feeds back the above channel state information to the base station after receiving a request of the base station for feedback. And as for the active mode, the feedback is triggered by the UE automatically, that is, the UE feeds back the above channel state information to the base station after detecting that the topology of its neighboring UE changes, such as appearance of a new neighboring UE, and/or missing of an existing neighboring UE, etc. A manner of detecting the topology of its neighboring UE by the UE is not limited in this embodiment, and various existing manners capable of detecting appearance and/or missing of the UE are applicable to this embodiment.

In this embodiment, feedback manners of the channel state information may be divided into periodic feedback and aperiodic feedback from an angle of feedback status, that is, the UE may perform the above feedback periodically or aperiodically; and it may also be divided into absolute feedback and differential feedback, or partial feedback and full feedback, from an angle of feedback amount. Besides, the above feedback manners may be used alternately, and particular feedback manners may be determined by preconfiguring or presetting.

In the feedback manners of absolute feedback and differential feedback, for the absolute feedback, the UE may feed back the above channel state information of all its neighboring UEs each time, and for the differential feedback, the UE may feed back different parts from previous feedback (such as feedback of the last time). For example, for UE1, the periodic feedback manner is used to feed back the above channel state information of its neighboring UEs, and in a first time of feedback, UE1 feeds back channel state information of UE2, UE3, UE4 and UE5, and thereafter, topology of neighboring UEs of UE1 changes, for example, UE2 leaves (and is no longer a neighbor of UE1), and UE6 joins in (and becomes a neighbor of UE1), and in a second time of feedback, UE1 feeds back only channel state information of UE2 and UE6. In this embodiment, for a case where topology of the UEs changes relatively fast, the absolute feedback may be taken into account, and for a case where topology of the UEs does not change or changes relatively slow, the differential feedback may be taken into account, in which case appearance of new neighboring UE and/or leaving of existing UE is/are not too frequent, and feedback of the channel state information in the differential feedback manner may greatly save feedback overhead.

In the feedback manners of partial feedback and full feedback, for the partial feedback, the UE may feed back channel state information of one of or a part of neighboring UEs each time, and for the full feedback, the UE may feed back the channel state information of all its neighboring UEs each time. And a particular feedback manner may be determined as demanded or according to properties of feedback resources.

With the method of this embodiment, the UE feeds back the channel state information of its neighboring UE(s) to the base station, and the base station constructs the topology of UEs according to the channel state information fed back by the UEs, so as to better allocate resources for the UEs, thereby reducing resource collisions and improving signal quality.

### Embodiment 2

The embodiment of the present disclosure provides a method for allocating resources, which is applicable to a base station, and is processing at a base station side corresponding to the method of Embodiment 1, which contents identical to those in Embodiment 1 being not going to be described herein any further.

FIG. 2 is a schematic diagram of an implementation of the method of this embodiment. As shown in FIG. 2, the method includes:

step 201: the base station receives channel state information fed back by a UE, the channel state information including a link ID of a link between the UE and a neighboring UE, and/or a UEID of the neighboring UE; and

step 202: the base station allocates resources for each UE according to the channel state information fed back by each UE.

In step 201, reference may be made to Embodiment 1 for feedback resources of the channel state information, a manner for triggering feedback, a feedback manner and contents contained in the channel state information, and corresponding contents in Embodiment 1 are incorporated herein, which shall not be described herein any further.

In step 202, after receiving the above channel state information fed back by the UEs, the base station may construct topology of the UEs, so as to allocate resources for the UEs, thereby reducing resource collisions and improving signal quality.

In this embodiment, a particular manner for allocating resources is not limited, and any manner for allocating resources for the UEs according to channel state information fed back by the UEs is applicable to this embodiment. An implementation of a manner for allocating resources of this embodiment shall be described below, and this implementation is illustrative only, and is not intended to limit this embodiment.

In this implementation, a process for allocating resources may be carried out by a method shown in FIG. 3. As shown in FIG. 3, the method includes:

step 301: the base station determines a set of UEs and a set of neighboring relationships between the UEs according to channel state information fed back by the UEs; and

step 302: the base station allocates time-domain resources for the UEs by using configurable transmission time instances.

In this embodiment, the set of UEs and the set of neighboring relationships between the UEs are determined, that is, topology of the UEs is determined. Hence, the base station may allocate resources for the UEs with reference to the topology of the UEs, such as allocating the configurable transmission time instances for the UEs, so as to make transmitting time instances of UEs having neighboring relationships to be different and/or frequency-domain resources of UEs having identical transmitting time instances to be different, thereby reducing resource collisions and improving signal quality.

In step 301, the set of UEs contains all UEs feeding back the above channel state information, and alternatively, the set of UEs may further contain UE(s) not feeding back the above channel state information but appearing as neighboring UE(s) of the UE feeding back the above channel state information. And in step 301, the set of neighboring relationships contains neighboring relationships between the UEs in the above set of UEs.

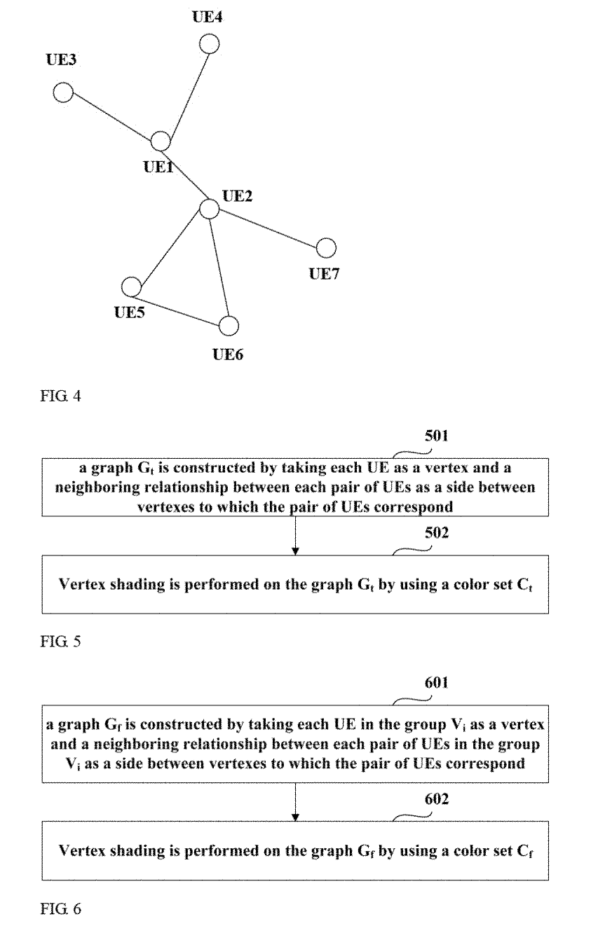

Taking FIG. 4 as an example, it is assumed that UE1 feeds back CSI of UE2, UE3 and UE4, UE2 feeds back CSI of UE1, UE5, UE6 and UE7, UE3 and UE4 feed back CSI of UE1, UE5 feeds back CSI of UE2 and UE6, UE6 feeds back CSI of UE2 and UE5, and UE7 does not feed back CSI of any UE, but is fed back by UE2 as neighboring UE of UE2, then the set of UEs contains UE1, UE2, UE3, UE4, UE5, UE6 and UE7, and the set of neighboring relationships contains respective neighboring relationships between UE1 and UE2, UE3, UE4, respective neighboring relationships between UE2 and UE5, UE6, UE7, and a neighboring relationship between UE5 and UE6. And for UE1 and UE2, UE1 and UE3, UE1 and UE4, UE2 and UE5, UE2 and UE6, and UE5 and UE6, the CSI is fed back twice, and the neighboring relationships between these UEs may be correspondingly weighted.

In this implementation, if the channel state information fed back by the UEs further includes the above optional contents, such as any one of the following or a combination thereof: received signal strength from each neighboring UE received by the UE, and/or estimated distance from the UE to each neighboring UE, and/or estimated path loss from the UE to each neighboring UE, the neighboring relationships between the UEs may be correspondingly weighted. And a particular method for weighting is not limited in this embodiment.

In step 302, the resource allocation includes time-domain resource allocation and frequency-domain resource allocation; wherein, the frequency-domain resource allocation is optional, that is, if time-domain resources of all UEs having neighboring relationships cannot be differentiated via the time-domain resource allocation, the frequency-domain resource allocation may further be used to differentiate UEs having identical time-domain resources.

In step 302, the configurable transmission time instances are the time-domain resources, and refer to instances that can be used for transmitting packets of a V2V message, and for a periodic traffic, the number of the configurable transmission time instances may be equal to or less than a quotient of a period of the periodic traffic divided by a duration of each time of transmission. For example, if traffics of the UEs are all periodic traffics of a period of 10 milliseconds and each time of transmission needs to occupy 2 milliseconds, the number of the configurable transmission time instances is 5, with their respective period offsets being {0,1}, {2,3}, {4,5}, {6,7}, {8,9}.

In this implementation, if the configurable transmission time instances are insufficient to make transmitting time instances of all UEs having neighboring relationships to be different, UE without allocated time-domain resources may be allocated with resources by cyclically using the configurable transmission time instances.

Still taking FIG. 4 as an example, it is assumed that the number of the configurable transmission time instances is 2, which are t1 and t2, as there exist neighboring relationships between UE1 and UE2, UE3, UE4, there exists no neighboring relationship between UE2, UE3, UE4, and there exists a neighboring relationship between UE7 and UE2 and there exists no neighboring relationship between UE7 and UE1, t1 may be allocated for UE1 and UE7, and t2 may be allocated for UE2, UE3 and UE4. However, as there exist two-two neighboring relationships between UE2 and UE5, UE6 and the current two transmission time instances are insufficient to be allocated for the three UEs, subsequent frequency-domain resources allocation may be continued for UEs having identical transmission time instances.

As shown in FIG. 3, the method may further include:

step 303: the base station allocates resources for the UEs with identical transmitting time instances according to channel state information fed back by the UEs.

In this implementation, step 303 may be carried out by the method below, the method includes:

step 3031: a set of the UEs with identical transmitting time instances is determined;

step 3032: a set of neighboring relationships between the UEs with identical transmitting time instances is determined according to the channel state information and interference and/or distances between the UEs with identical transmitting time instances; and

step 3033: resources are allocated for the UEs with identical transmitting time instances by using available frequency-domain resources.

In step 3031, the set of UEs is the set of UEs allocated with identical transmitting time instances in the above-described time-domain resource allocation process. Still taking FIG. 4 as an example, it is assumed that UE5 is allocated with t1 and UE6 is allocated with t2, the set of UEs may be UE1, UE5 and UE7 which are allocated with t1, or may be UE2, UE3, UE4 and UE6 which are allocated with t2.

In step 3032, the set of neighboring relationships needs also to be determined, and what is different from the time-domain allocation process is that the set of neighboring relationships here needs to not only take channel information fed back by the UEs into account, but also take the interference and/or distances between the UEs in the set of UEs into account.

In this implementation, if interference between two UEs is greater than an interference threshold, it is determined that there exists a neighboring relationship between the two UEs; or, if a distance between two UEs is less than a distance threshold, it is determined that there exists a neighboring relationship between the two UEs. In this implementation, the interference threshold and the distance threshold may be predefined or may be configured flexibly by the base station according to velocities, and densities, etc., of the UE, and a particular configuration method is not limited in this disclosure.

In this implementation, the distance refers to the number of sides of a link having a minimum number of sides in links between the two UEs. Taking that the set of UEs contains UE1, UE5 and UE7 as an example, as shown in FIG. 4, there exist two links between UE5 and UE1, one is UE1→UE2→UE5, and the other is UE1→UE2→UE6→UE5, then number 2 of sides of the link UE1→UE2→UE5 is less than then number 3 of sides of the link UE1→UE2→UE6→UE5, and it is deemed that a distance between UE1 and UE5 is 2.

In this implementation, if the channel state information fed back by the UEs further includes the above optional contents, such as any one of the following or a combination thereof: received signal strength from each neighboring UE received by the UE, and/or estimated distance from the UE to each neighboring UE, and/or estimated path loss from the UE to each neighboring UE, the neighboring relationships (i.e. distances) between the UEs may be correspondingly weighted. And a particular method for weighting is not limited in this embodiment.

In step 3033, similar to the time-domain resource allocation, if the above-described available frequency-domain resources are insufficient to make frequency-domain resources of UEs in the set of UEs having neighboring relationships to be different, the base station may allocate resources for UEs without allocated frequency-domain resources by cyclically using the available frequency-domain resources. And in allocating resources for the UEs without allocated frequency-domain resources by cyclically using the available frequency-domain resources, interference suppression may be taken into account, so that two UEs relatively far away from each other use identical frequency-domain resources, and mutual interference thereof is tolerable or less than a threshold.

With the method of this embodiment, the base station may construct the topology of the UEs according to the channel state information fed back by the UEs, so as to better allocate resources for the UEs, thereby reducing resource collisions and improving signal quality.

In this embodiment, the problem of resource allocation may be modeled into a vertex shading problem in a graph theory. Hence, the problem of resource allocation may be divided into two sequential sub-problems, time-domain resource allocation and frequency-domain resource allocation, the frequency-domain resource allocation being optional. And for each problem, topology of the UEs may be respectively modeled, and vertexes of graphs may be respectively shaded. The method for allocating resources of this embodiment shall be described below from a point of view of the graph theory.

About the time-domain resource allocation

In this implementation, in order to improve a transmission efficiency of V2V messages, such as a packet reception ratio (PRR), coordination needs to be introduced into the time-domain resource allocation, so as to ensure that there are a number of UEs around a packet of each V2V message to receive the packet; otherwise, half-duplex limitation will greatly reduce a PRR of the packet of the V2V message, which is more severe when the UEs are distributed in clusters. For periodic traffics, the time-domain resource allocation is to determine a subframe offset of each periodic packet stream.

FIG. 5 is a schematic diagram of the time-domain resource allocation of this implementation. As shown in FIG. 5, the time-domain resource allocation process includes:

step 501: a graph [symbol] ₜ(ν,εₜ) is constructed by taking each UE as a vertex and a neighboring relationship between each pair of UEs as a side between vertexes to which the pair of UEs correspond; and

step 502: vertex shading is performed on the graph [symbol] ₜ(ν,εₜ) by using a color set Cₜ.

In step 501, V is the set of UEs, which may be denoted as ν [symbol] {v₁,v₂, . . . }, and εₜ is the set of neighboring relationships between the UEs, which may be denoted as εₜ [symbol] {e₁^{t},e₂^{t},. . . }. The topology of the UEs is obtained by constructing the above graph [symbol] ₜ(ν,εₜ). In this implementation, as described above, if optional parts in the above channel state information are also fed back, the side between the two vertexes may be correspondingly weighted.

In step 502, each configurable transmitting time instance may be denoted as a color, and all configurable transmitting time instances are denoted as a color set Cₜ [symbol] {c₁^{t}, c₂^{t}, . . . }. The color set Cₜ [symbol] {c₁^{t},c₂^{t}, . . . } may be used to perform vertex shading on the graph [symbol] ₜ(v, εₜ). And a particular shading method is not limited in this embodiment, and any existing mature algorithm in the graph theory is applicable.

In this implementation, for the periodic traffics, the configurable transmitting time instances are, for example, subframe offsets of the periodic traffics, and the number of the configurable transmitting time instances may be equal to periods of the periodic traffics.

In this implementation, if configurable colors are too few to shade all vertexes in the graph [symbol] ₜ(v,εₜ), that is, |cₜ|<ₓ( [symbol] ₜ(v, εₜ)), the configurable colors may be reused. For example, the color set Cₜ [symbol] {c₁^{t},c₂^{t}, . . . } may be taken as a cyclic chain table. And when a last available color c^{t}|c| is used out, a first color c₁^{t} will be reused as a next new color.

With the method shown in FIG. 5, the time-domain resource allocation is achieved.

About the frequency-domain resource allocation

In this implementation, after the time-domain resource allocation, all UEs may be divided into a number of groups, that is, v=v₁∩v₂∩. . . ∩vₘᵢₙ(|cₜ|, x(z,29 ₜ(v, εₜ))). In this implementation, transmitting time instances of UEs in the same group are identical, and correspond to vertexes shaded with identical colors in the time-domain resource allocation. The frequency-domain resource allocation needs to be performed on each UE in each group of UEs having identical colors.

FIG. 6 is a schematic diagram of the frequency-domain resource allocation of this implementation. Without limitation of generality, in this example, a group vᵢ is taken as an example. As shown in FIG. 6, the frequency-domain resource allocation process includes: step 601: a graph [symbol] _{f}(Vᵢ, εᵢ^{f}) is constructed by taking each UE in the group vᵢ as a vertex and a neighboring relationship between each pair of UEs in the group vᵢ as a side between vertexes to which the pair of UEs correspond; where, i=1,2, . . . , min(|cₜ|,x (z,29 (v,εₜ))); and step 602: vertex shading is performed on the graph [symbol] _{f}(vᵢ,εᵢ^{f}) by using a color set C_{f}.

In step 601, Vᵢ is a set of UEs in the group vᵢ, which may be denoted as vᵢ [symbol] {v_{i,1},v_{i,2},. . . }, and εᵢ^{f} is a set of neighboring relationships between the UEs, which may be denoted as εᵢ^{f} [symbol] {e_{i,1},e_{i,2}, . . . }. The topology of the UEs in the group vᵢ is obtained by constructing the above graph [symbol] _{f}(Vᵢ,εᵢ^{f}).

In this implementation, in comparison with the time-domain resource allocation, “the neighboring relationships” in the frequency-domain resource allocation have wider meanings, which not only contain the neighboring relationships fed back based on the above-described channel state information, but also contain neighboring relationships that interference between two UEs is greater than an interference threshold and/or a distance between two UEs is less than a distance threshold. In this implementation, “the distance” here refers to the number of sides of a shortest path between two vertexes. In this implementation, as described above, if optional parts in the above channel state information are also fed back, “the distance” between the two vertexes may be correspondingly weighted. In this implementation, as described above, the interference threshold and the distance threshold may be predefined or may be configured flexibly by the base station according to velocities, and densities, etc., of the UE.

In step 602, each frequency-domain resource unit may be denoted as a color, and all colors are denoted as a color set c_{f} [symbol] {c₁^{f},c₂^{f},. . . }. The color set c_{f} [symbol] {c₁^{f},c₂^{f}, . . . } may be used to perform vertex shading on the graph [symbol] _{f}(vᵢ, εᵢ^{f}). And a particular shading method is not limited in this embodiment, and any existing mature algorithm in the graph theory is applicable.

In this implementation, if frequency-domain resources are insufficient or configurable colors are too few to shade all vertexes in the graph [symbol] _{f}(vᵢ,εᵢ^{f}), that is, |C_{f}|<x ( [symbol] _{f}(Vᵢ,εᵢ^{f})), the colors (i.e. the frequency-domain resources) may be reused. For example, the color set c_{f} [symbol] {c₁^{f},c₂^{f},. . . } may be taken as a cyclic chain table. In this implementation, in the reuse process, interference suppression may be taken into account, that is, identical colors (identical frequency-domain resource units) are reused between vertexes relatively far away from each other, so as to ensure that mutual interference between the UEs is tolerable or less than a threshold.

With the method shown in FIG. 6, the frequency-domain resource allocation is achieved.

### Embodiment 3

This embodiment provides an apparatus for feeding back channel state information, configured in a UE. As principles of the apparatus for solving problems are similar to that of the method of Embodiment 1, the implementation of the method of Embodiment 1 may be referred to for implementation of the apparatus, with identical contents being not going be described herein any further.

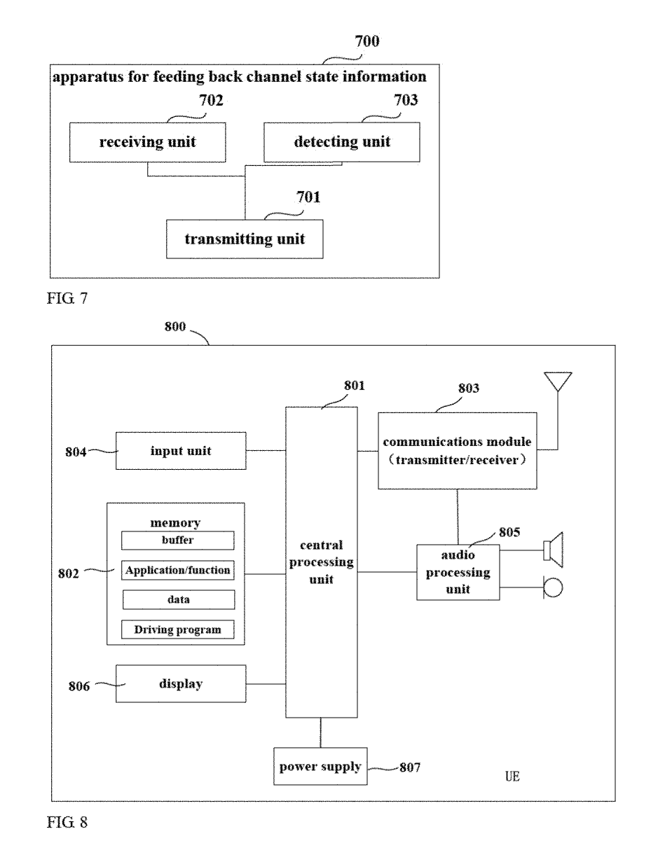

FIG. 7 is a schematic diagram of the apparatus for feeding back channel state information. As shown in FIG. 7, the apparatus 700 includes: a transmitting unit 701 configured to feed back channel state information to a base station, the channel state information including a link ID of a link between the UE and neighboring UE, and/or a UEID of the neighboring UE, so that the base station allocates resources for each UE according to the channel state information fed back by each UE. Alternatively, the channel state information may further include any one of the following or a combination thereof:

received signal strength from each neighboring UE received by the UE; and/or

estimated distance from the UE to each neighboring UE; and/or

estimated path loss from the UE to each neighboring UE.

In this embodiment, the transmitting unit 701 may feed back the channel state information to the base station via a physical uplink channel, such as a physical uplink shared channel and/or a physical uplink control channel.

In one implementation, as shown in FIG. 7, the apparatus 700 may further include:

a receiving unit 702 configured to receive a feedback request from the base station. In this implementation, feedback of the channel state information is passively triggered, that is, the transmitting unit 701 feeds back the channel state information to the base station after the receiving unit 702 receives the feedback request from the base station.

In another implementation, as shown in FIG. 7, the apparatus 700 may further include:

a detecting unit 703 configured to detect topology of the neighboring UEs of the UE. In this implementation, feedback of the channel state information is actively triggered, that is, the transmitting unit 701 actively feeds back the channel state information to the base station after the detecting unit 703 detects that the topology of the neighboring UEs of the UE changes.

In this embodiment, the transmitting unit 701 may periodically or aperiodically perform the above feedback, and/or the transmitting unit 701 may feed back the channel state information of all neighboring UEs of the UE, or may feed back different parts from previous feedback, and/or the transmitting unit 701 may feed back the channel state information of one or a part of neighboring UEs of the UE each time, or the transmitting unit 701 may feed back the channel state information of all neighboring UEs of the UE each time.

By feeding back the channel state information by the apparatus of this embodiment to the base station, the base station may construct the topology of the UEs according to the channel state information fed back by the UEs, so as to better allocate resources for the UEs, thereby reducing resource collisions and improving signal quality.

This embodiment further provides a UE, configured with the above-described apparatus 700 for feeding back channel state information.

FIG. 8 is a schematic diagram of the UE 800 of the embodiment of this disclosure. As shown in FIG. 8, the UE 800 may include a central processing unit 801 and a memory 802, the memory 802 being coupled to the central processing unit 801. It should be noted that this figure is illustrative only, and other types of structures may also be used, so as to supplement or replace this structure and achieve a telecommunications function or other functions.

In one implementation, the functions of the apparatus for feeding back channel state information may be integrated into the central processing unit 801. In this implementation, the central processing unit 801 may be configured to carry out the method for feeding back channel state information described in Embodiment 1.

For example, the central processing unit 801 may be configured to: feed back channel state information to a base station, the channel state information including a link ID of a link between the UE and neighboring UE, and/or a UEID of the neighboring UE, so that the base station allocates resources for each UE according to the channel state information fed back by each UE.

Alternatively, the channel state information may further include any one of the following or a combination thereof:

received signal strength from each neighboring UE received by the UE; and/or

estimated distance from the UE to each neighboring UE; and/or

estimated path loss from the UE to each neighboring UE.

Alternatively, the central processing unit 801 may further be configured to: feed back the channel state information to the base station via a physical uplink shared channel and/or a physical uplink control channel.

Alternatively, the central processing unit 801 may further be configured to: feed back the channel state information to the base station after receiving a feedback request from the base station.

Alternatively, the central processing unit 801 may further be configured to: feed back the channel state information to the base station after detecting that the topology of the neighboring UEs of the UE changes.

Alternatively, the central processing unit 801 may further be configured to: periodically or aperiodically perform the above feedback.

Alternatively, the central processing unit 801 may further be configured to: feed back the channel state information of all neighboring UEs of the UE, or feed back different parts from previous feedback.

Alternatively, the central processing unit 801 may further be configured to: feed back the channel state information of one or a part of neighboring UEs of the UE each time, or feed back the channel state information of all neighboring UEs of the UE each time.

In another implementation, the apparatus for feeding back channel state information and the central processing unit 801 may be configured separately. For example, the apparatus for feeding back channel state information may be configured as a chip connected to the central processing unit 801, with its functions being realized under control of the central processing unit 801.

As shown in FIG. 8, the UE 800 may further include a communications module 803, an input unit 804, an audio processing unit 805, a display 806 and a power supply 807. It should be noted that the UE 800 does not necessarily include all the parts shown in FIG. 8, and furthermore, the UE 800 may include parts not shown in FIG. 8, and the related art may be referred to.

As shown in FIG. 8, the central processing unit 801 is sometimes referred to as a controller or control, which may include a microprocessor or other processor devices and/or logic devices, and the central processing unit 801 receives input and controls operations of every component of the UE 800.

In this implementation, the memory 802 may be, for example, one or more of a buffer memory, a flash memory, a hard drive, a mobile medium, a volatile memory, a nonvolatile memory, or other suitable devices, which may store various information, and furthermore, store programs executing related information. And the central processing unit 801 may execute programs stored in the memory 802, so as to realize information storage or processing, etc. Functions of other parts are similar to those of the related art, which shall not be described herein any further. The parts of the terminal device 800 may be realized by specific hardware, firmware, software, or any combination thereof, without departing from the scope of the present disclosure.

By feeding back the channel state information by the UE of this embodiment to the base station, the base station may construct the topology of the UEs according to the channel state information fed back by the UEs, so as to better allocate resources for the UEs, thereby reducing resource collisions and improving signal quality.

### Embodiment 4

This embodiment provides an apparatus for allocating resources, configured in a base station. As principles of the apparatus for solving problems are similar to that of the method of Embodiment 2, the implementation of the method of Embodiment 2 may be referred to for implementation of the apparatus, with identical contents being not going be described herein any further.

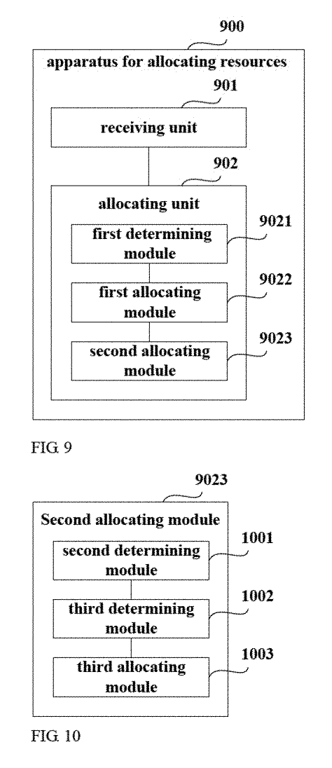

FIG. 9 is a schematic diagram of the apparatus for allocating resources of this embodiment. As shown in FIG. 9, the apparatus 900 includes a receiving unit 901 and an allocating unit 902.

In this embodiment, the receiving unit 901 receives channel state information fed back by a UE, the channel state information including a link ID of a link between the UE and a neighboring UE, and/or a UEID of the neighboring UE. As the channel state information has been described in detail in the above embodiments, the contents of which are incorporated herein, and shall not be described herein any further.

In this embodiment, the allocating unit 902 allocates resources for each UE according to the channel state information fed back by each UE. A particular method for allocating resources is not limited in this embodiment, which shall be described below by way of examples.

In one implementation, as shown in FIG. 9, the allocating unit 902 includes a first determining module 9021 and a first allocating module 9022. The first determining module 9021 determines a set of UEs and a set of neighboring relationships between the UEs according to channel state information fed back by the UEs, and the first allocating module 9022 allocates resources for the UEs by using configurable transmission time instances.

In this implementation, if the number of the configurable transmission time instances is insufficient to make transmitting time instances of all UEs having neighboring relationships in the set of UEs to be different, the first allocating module 9022 allocates resources for UEs without allocated time-domain resources by cyclically using the configurable transmission time instances.

In this implementation, if the channel state information further includes any one of the following or a combination thereof: received signal strength from each neighboring UE received by the UE; and/or estimated distance from the UE to each neighboring UE; and/or estimated path loss from the UE to each neighboring UE. And the neighboring relationships between the UEs are correspondingly weighted.

In another implementation, as shown in FIG. 9, the allocating unit 902 may further include a second allocating module 9023 configured to allocate resources for each UE with identical transmitting time instances according to channel state information fed back by each UE.

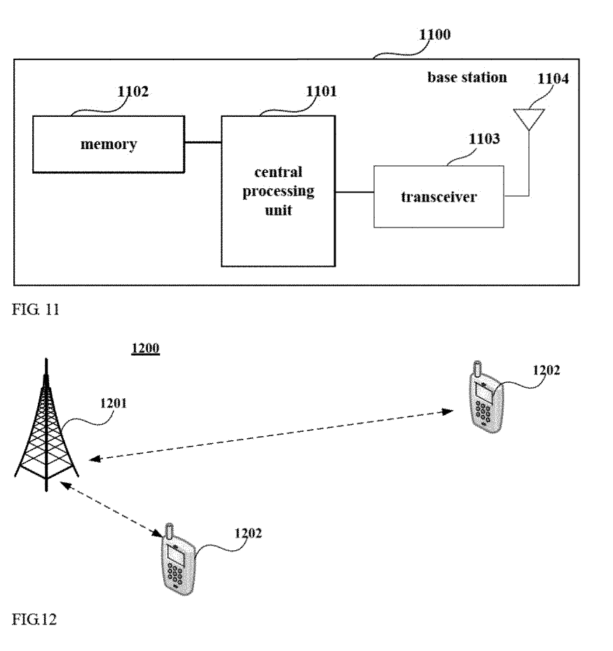

In this implementation, as shown in FIG. 10, the second allocating module 9023 may further include a second determining module 1001, a third determining module 1002 and a third allocating module 1003.

The second determining module 1001 determines a set of UEs with identical transmitting time instances.

The third determining module 1002 determines a set of neighboring relationships between the UEs with identical transmitting time instances according to the channel state information and interference and/or distances between the UEs with identical transmitting time instances.

And the third allocating module 1003 allocates resources for the UEs with identical transmitting time instances by using available frequency-domain resources.

In this implementation, the third determining module 1002 determines that there exists a neighboring relationship between two UEs when interference between the two UEs is greater than an interference threshold.

In this implementation, the third determining module 1002 determines that there exists a neighboring relationship between two UEs when a distance between the two UEs is less than a distance threshold.

In this implementation, the distance is the number of sides of a link having a minimum number of sides in links between the two UEs.

In this implementation, if the channel state information further includes any one of the following or a combination thereof: received signal strength from each neighboring UE received by the UE, and/or estimated distance from the UE to each neighboring UE, and/or estimated path loss from the UE to each neighboring UE, the neighboring relationships between the UEs are correspondingly weighted.

In this implementation, if the number of the available frequency-domain resources is insufficient to make frequency-domain resources of UEs in the set of UEs having neighboring relationships to be different, the third allocating module 1003 allocates resources for UEs without allocated frequency-domain resources by cyclically using the available frequency-domain resources.

By constructing the topology of the UEs according to the channel state information fed back by the UEs, resources may be better allocated for the UEs, thereby reducing resource collisions and improving signal quality.

This embodiment further provides a base station, configured with the above-described apparatus 900 for allocating resources.

FIG. 11 is a schematic diagram of the base station of the embodiment of this disclosure. As shown in FIG. 11, the base station 1100 may include a central processing unit (CPU) 1101 and a memory 1102, the memory 1102 being coupled to the central processing unit 1101. In this embodiment, the memory 1102 may store various data, and furthermore, it may store a program for information processing, and execute the program under control of the central processing unit 1101, so as to receive various information transmitted by the UE, and transmit request information to the UE.

In one implementation, the functions of the apparatus for allocating resources may be integrated into the central processing unit 1101. In this implementation, the central processing unit 1101 may be configured to carry out the method for allocating resources as described in Embodiment 2.

For example, the central processing unit 1101 may be configured to: receive channel state information fed back by a UE, the channel state information including a link ID of a link between the UE and a neighboring UE, and/or a UEID of the neighboring UE; and allocate resources for each UE according to the channel state information fed back by each UE.

Alternatively, in one implementation, the central processing unit 1101 may further be configured to: determine a set of UEs and a set of neighboring relationships between the UEs according to channel state information fed back by the UEs; and allocate resources for the UEs by using configurable transmission time instances.

Alternatively, if the number of configurable transmission time instances is insufficient to make transmitting time instances of all UEs having neighboring relationships in the set of UEs to be different, the central processing unit 1101 may further be configured to: allocate resources for UEs without allocated time-domain resources by cyclically using the configurable transmission time instances.

Alternatively, if the channel state information further includes any one of the following or a combination thereof: received signal strength from each neighboring UE received by the UE, and/or estimated distance from the UE to each neighboring UE, and/or estimated path loss from the UE to each neighboring UE, the central processing unit 1101 may further be configured to: correspondingly weight the neighboring relationships between the UEs.

Alternatively, in another implementation, the central processing unit 1101 may further be configured to: allocate resources for each UE with identical transmitting time instances according to channel state information fed back by each UE.

Alternatively, the central processing unit 1101 may further be configured to: determine a set of the UEs with identical transmitting time instances; determine a set of neighboring relationships between the UEs with identical transmitting time instances according to the channel state information and interference and/or distances between the UEs with identical transmitting time instances; and allocate resources for the UEs with identical transmitting time instances by using available frequency-domain resources.

Alternatively, if interference between the two UEs is greater than an interference threshold, the central processing unit 1101 may further be configured to: determine that there exists a neighboring relationship between the two UEs.

Alternatively, if a distance between the two UEs is less than a distance threshold, the central processing unit 1101 may further be configured to: determine that there exists a neighboring relationship between the two UEs.

Alternatively, the distance is the number of sides of a link having a minimum number of sides in links between the two UEs.

Alternatively, if the channel state information further includes any one of the following or a combination thereof: received signal strength from each neighboring UE received by the UE, and/or estimated distance from the UE to each neighboring UE, and/or estimated path loss from the UE to each neighboring UE, the central processing unit 1101 may further be configured to: correspondingly weight the neighboring relationships between the UEs.

Alternatively, if the number of available frequency-domain resources is insufficient to make frequency-domain resources of UEs in the set of UEs having neighboring relationships to be different, the central processing unit 1101 may further be configured to: allocate resources for UEs without allocated frequency-domain resources by cyclically using the available frequency-domain resources.

In another implementation, the apparatus for allocating resources and the central processing unit 1101 may be configured separately. For example, the apparatus for allocating resources may be configured as a chip connected to the central processing unit 1101, with its functions being realized under control of the central processing unit 1101.

Furthermore, as shown in FIG. 11, the base station 1100 may include a transceiver 1103, and an antenna 1104, etc. In this embodiment, functions of the above components are similar to those in the related art, and shall not be described herein any further. It should be noted that the base station 1100 does not necessarily include all the parts shown in FIG. 11, and furthermore, the base station 1100 may include parts not shown in FIG. 11, and the related art may be referred to.

By constructing the topology of the UEs by the base station of this embodiment according to the channel state information fed back by the UEs, resources may be better allocated for the UEs, thereby reducing resource collisions and improving signal quality.

### Embodiment 5

This embodiment provides a communications system, including the base station as described in Embodiment 4 and the UE as described in Embodiment 3.

FIG. 12 is a schematic diagram of the communications system of the embodiment of this disclosure. As shown in FIG. 12, the communications system 1200 includes a base station 1201 and a UE 1202. In this embodiment, the base station 1201 may be the base station 1100 as described in Embodiment 4, and the UE 1202 may be the UE 800 as described in Embodiment 3.

For example, the UE 1202 may be configured to: feed back channel state information to the base station 1201, the channel state information including a link ID of a link between the UE and neighboring UE, and/or a UEID of the neighboring UE; and the base station 1201 may be configured to: receive the channel state information fed back by the UE 1202, and allocate resources for each UE according to the channel state information fed back by each UE.

As the base station and the UE have been described in detail in the previous embodiments, the contents of which are incorporated herein, and shall not be described herein any further.

With the communications system of this embodiment, the UE feeds back the channel state information of its neighboring UE to the base station, and the base station may allocate resources for each UE according to the channel state information fed back by each UE, thereby reducing resource collisions and improving signal quality.

An embodiment of the present disclosure provides a computer readable program, which, when executed in an information processing apparatus or a UE, will cause a computer to carry out the method for feeding back channel state information described in Embodiment 1 in the information processing apparatus or the UE.

An embodiment of the present disclosure provides a computer storage medium, including a computer readable program, which will cause a computer to carry out the method for feeding back channel state information described in Embodiment 1 in an information processing apparatus or a UE.

An embodiment of the present disclosure provides a computer readable program, which, when executed in an information processing apparatus or a base station, will cause a computer to carry out the method for allocating resources described in Embodiment 2 in the information processing apparatus or the base station.

An embodiment of the present disclosure provides a computer storage medium, including a computer readable program, which will cause a computer to carry out the method for allocating resources described in Embodiment 2 in an information processing apparatus or a base station.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The method for feeding back channel state information carried out in the apparatus for feeding back channel state information or the method for allocating resources carried out in the apparatus for allocating resources described with reference to the embodiments of this disclosure may be directly embodied as hardware, software modules executed by a processor, or a combination thereof. For example, one or more functional block diagrams and/or one or more combinations of the functional block diagrams shown in FIG. 7 or 9 (such as a . . . unit, a . . . unit, a . . . unit, etc.) may either correspond to software modules of procedures of a computer program, or correspond to hardware modules. Such software modules may respectively correspond to the steps shown in FIG. 1 or 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 7 or 9 (such as a . . . unit, a . . . unit, a . . . unit, etc.) may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 7 or 9 may also be realized as a combination of computing equipment, such as a combination of a DSP and a microprocessor, multiple processors, one or more microprocessors in communications combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for feeding back channel state information, configured in a UE, the apparatus comprising:
a transmitting unit configured to feed back channel state information to a base station, the channel state information comprising a link ID of a link between the UE and a neighboring UE, and/or a UEID of the neighboring UE, so that the base station allocates resources for each UE according to the channel state information fed back by each UE.

2. The apparatus according to claim 1, wherein the channel state information further comprises any one of the following or a combination thereof:
received signal strength from each neighboring UE received by the UE; and/or
estimated distance from the UE to each neighboring UE; and/or
estimated path loss from the UE to each neighboring UE.

3. The apparatus according to claim 1, wherein the transmitting unit feeds back the channel state information to the base station via a physical uplink shared channel and/or a physical uplink control channel.

4. The apparatus according to claim 1, wherein the apparatus further comprises:
a receiving unit configured to receive a feedback request from the base station;
and the transmitting unit feeds back the channel state information to the base station after the receiving unit receives the feedback request from the base station.

5. The apparatus according to claim 1, wherein the apparatus further comprises:
a detecting unit configured to detect topology of the neighboring UEs of the UE;
and the transmitting unit feeds back the channel state information to the base station after the detecting unit detects that the topology of the neighboring UEs of the UE changes.

6. The apparatus according to claim 1, wherein the transmitting unit periodically or aperiodically performs the above feedback.

7. The apparatus according to claim 1, wherein the transmitting unit feeds back the channel state information of all neighboring UEs of the UE, or feeds back the part of the channel state information which is different from previous feedback.

8. The apparatus according to claim 1, wherein the transmitting unit feeds back the channel state information of one or a part of neighboring UEs of the UE each time, or the transmitting unit feeds back the channel state information of all neighboring UEs of the UE each time.

9. An apparatus for allocating resources, configured in a base station, the apparatus comprising:
a receiving unit configured to receive channel state information fed back by a UE, the channel state information comprising a link ID of a link between the UE and a neighboring UE, and/or a UEID of the neighboring UE; and
an allocating unit configured to allocate resources for each UE according to the channel state information fed back by each UE.

10. The apparatus according to claim 9, wherein the allocating unit comprises:
a first determining module configured to determine a set of UEs and a set of neighboring relationships between the UEs according to channel state information fed back by the UEs; and
a first allocating module configured to allocate resources for the UEs by using configurable transmission time instances.

11. The apparatus according to claim 10, wherein if the configurable transmission time instances are insufficient to make transmitting time instances of all UEs having neighboring relationships in the set of UEs to be different, the first allocating module allocates resources for UEs without allocated time-domain resources by cyclically using the configurable transmission time instances.

12. The apparatus according to claim 10, wherein the channel state information further comprises any one of the following or a combination thereof:
received signal strength from each neighboring UE received by the UE; and/or
estimated distance from the UE to each neighboring UE; and/or
estimated path loss from the UE to each neighboring UE;
and the neighboring relationships between the UEs determined by the first determining module are correspondingly weighted.

13. The apparatus according to claim 10, wherein the allocating unit further comprises:
a second allocating module configured to allocate resources for each UE with identical transmitting time instances according to channel state information fed back by each UE.

14. The apparatus according to claim 13, wherein the second allocating module comprises:
a second determining module configured to determine a set of the UEs with identical transmitting time instances;
a third determining module configured to determine a set of neighboring relationships between the UEs with identical transmitting time instances according to the channel state information and interference and/or distances between the UEs with identical transmitting time instances; and
a third allocating module configured to allocate resources for the UEs with identical transmitting time instances by using available frequency-domain resources.

15. The apparatus according to claim 14, wherein the third determining module determines that there exists a neighboring relationship between two UEs when interference between the two UEs is greater than an interference threshold.

16. The apparatus according to claim 14, wherein the third determining module determines that there exists a neighboring relationship between two UEs when a distance between the two UEs is less than a distance threshold.

17. The apparatus according to claim 14, wherein the distance is the number of sides of a link having a minimum number of sides in links between the two UEs.

18. The apparatus according to claim 14, wherein the channel state information further comprises any one of the following or a combination thereof:
received signal strength from each neighboring UE received by the UE; and/or
estimated distance from the UE to each neighboring UE; and/or
estimated path loss from the UE to each neighboring UE;
and the neighboring relationships between the UEs are correspondingly weighted.

19. The apparatus according to claim 14, wherein if the available frequency-domain resources are insufficient to make frequency-domain resources of UEs in the set of UEs having neighboring relationships to be different, the third allocating module allocates resources for UEs without allocated frequency-domain resources by cyclically using the available frequency-domain resources.

20. A communications system, comprising a base station and a UE; wherein,
the UE is configured to feed back channel state information to the base station, the channel state information comprising a link ID of a link between the UE and a neighboring UE, and/or a UEID of the neighboring UE;
and the base station is configured to receive the channel state information fed back by the UE, and allocate resources for each UE according to the channel state information fed back by each UE.
